(19) United States
(12) Patent Application Publication
(10) Pub. No.: US 2016/0147405 A1
(43) Pub. Date: May 26, 2016

(54) PRESS AND DROP TEXT INPUT

(71) Applicant: SONY CORPORATION, Minato-Ku, Tokyo (JP)

(72) Inventor: Nabaz Barzangi, Lund (SE)

(21) Appl. No.: 14/348,154

(22) PCT Filed: Apr. 30, 2013
(86) PCT No.: PCT/JP13/62984

§ 371 Date: Mar. 28, 2014

(51) Int. Cl. G06F 3/0486; G06F 17/24; G06F 3/0488

(52) U.S. Cl. CPC G06F 3/0486; G06F 3/0488; G06F 17/24

(57) ABSTRACT

The present disclosure provides a method and a device for editing a text in an electronic device (7). The electronic device (7) comprises a memory (11) and a touchscreen (10) configured to display a text area (8) comprising the text to be edited and a keyboard area (9) comprising a number of symbols. The method comprises the steps of: detecting (1) the presence of an object at a first position on the touchscreen (10), wherein the first position is located in the keyboard area (9); identifying (2) one of the symbols based on the first position; storing (3) the symbol in the memory (11); detecting (4) the presence of an object at a second position on the touchscreen (10), wherein the second position is located in the text area (8) and pasting (5) the symbol in the text by inserting the symbol at the second position in the text area (8).

### TECHNICAL FIELD

The present disclosure relates to an electronic device with a memory and a touchscreen and a method for editing a text.

### BACKGROUND ART

Today many electronic devices are equipped with touchscreens. There are several ways of inputting and editing texts in such devices, for example simply pressing the letters one by one on a keyboard or by using T9, XT9 or Swype, where input of the full word is not needed. Such systems often use word prediction to determine what word the user is intending to write. However, the prediction is oftentimes slightly wrong, either in the spelling or in the conjunction or declension of the words and the user often needs to go back in the text and correct such errors. Even in the case when a user is not using word prediction or auto correction of words, it is easy to make spelling mistakes.

Going back in the text to correct errors is time consuming and impractical. Hence, there is a need for a simple and intuitive way of correcting such errors.

### SUMMARY

This disclosure enables simple correction of errors in a text on an electronic device. According to the disclosure, a method and an electronic device are provided which provides for a way to correct errors of the type where a symbol, e.g. a letter or punctuation, is missing in a text. This is achieved by a simple and intuitive way of editing a text in an electronic device.

With the above description in mind, then, an object of the present disclosure is to provide a method and a device for improving editing of texts in the device, which seeks to mitigate, alleviate, or eliminate one or more of the above-identified deficiencies in the art and disadvantages singly or in any combination.

According to one aspect of the disclosure, it provides for a method for editing a text in an electronic device. The electronic device comprising a memory and a touchscreen configured to display a text area comprising the text to be edited and a keyboard area comprising a number of symbols. The method comprises the steps of: detecting the presence of an object at a first position on the touchscreen, wherein the first position is located in the keyboard area; identifying one of the symbols based on the first position; storing the symbol in the memory; detecting the presence of an object at a second position on the touchscreen, wherein the second position is located in the text area and pasting the symbol in the text by inserting the symbol at the second position in the text area. By first identifying the presence of the object at a first position in the keyboard area and storing the symbol which the object has indicated in the memory, the symbol is pasted directly in the text area which is indicated next by the object so that a simple way of correcting errors in a text or editing a text is provided.

According to one aspect of the disclosure, it provides for an electronic device comprising: a touchscreen, configured to display a text area comprising text to be edited and a keyboard area comprising a number of symbols, a memory and a processing unit. The processing unit is arranged to detect the presence of an object at a first position on the touchscreen, wherein the first position is located in the keyboard area, identify one of the symbols based on the first position, store the symbol in the memory, detect the presence of an object at a second position on the touchscreen, wherein the second position is located in the text area and paste the symbol in the text by inserting the symbol at the second position in the text area. By providing the touchscreen, the memory and the processing unit the steps stated above may be implemented in the electronic device and a way to simplify editing of a text in the electronic device is provided.

According to one aspect of the disclosure, the symbol is displayed within a predetermined distance of the position where the presence of the object is detected. By displaying the symbol in the vicinity of the position where the object is detected, the user receives visual confirmation of which symbol he/she has chosen.

According to one aspect of the disclosure the presence of the object is constantly detected at the touchscreen when the object is moved between the first and the second position and wherein the detection of the presence of the object at the second position involves detection of a further action. In other words, the object is dragged over the surface of the touchscreen between the first and the second position. This feature makes the usage of the present disclosure intuitive for a user. If a symbol is missing somewhere in a text which the user is editing the user indicates which symbol to be inserted at a certain place in the text by dragging an object from the location of the chosen symbol in the keyboard area to the place in the text area where the user want the symbol pasted.

According to one aspect of the disclosure, the symbol is constantly displayed within a predetermined distance of the position where the presence of the object is detected when the object is moved between the first and the second position. By displaying the symbol in the vicinity of the position where the object is detected while moving the object between the first and the second position, the user receives visual confirmation of which symbol he/she has chosen as well as a visual indication of where the symbol is being dragged.

According to one aspect of the disclosure the step of detecting the presence of an object at a first position on the touchscreen further comprises that the object is present 6 at the first position for at least a predetermined amount of time. By waiting a predetermined amount of time before detecting the presence of an object the method is distinguished from other methods of typing and/or inserting text.

According to one aspect of the disclosure the object is a stylus or a finger. Using a stylus or a finger for indicating the first and the second position is practical for the user.

According to one aspect of the disclosure wherein the symbol is any of: a letter, a number, space, a character and/or punctuation. Any such symbol is used when editing text.

According to one aspect of the disclosure, it provides for a computer program, comprising computer readable code which, when run on a processing unit in an electronic device, causes the processing unit to perform the method according to above.

### BRIEF DESCRIPTION OF THE DRAWINGS

The present technique will be more readily understood through the study of the following detailed description of the embodiments/aspects together with the accompanying drawings, of which:

FIG. 1 illustrates a Smartphone where text may be inserted and edited.

FIG. 2 shows a flowchart of a method for editing a text.

FIG. 3 illustrates a Smartphone where a symbol is being dragged by an object.

It should be added that the following description of the embodiments is for illustration purposes only and should not be interpreted as limiting the disclosure exclusively to these embodiments/aspects.

### DETAILED DESCRIPTION

The general object or idea of the present disclosure is to address at least one or some of the disadvantages with the prior art solutions described above. The various steps described below in connection with the figures should be primarily understood in a logical sense.

Embodiments of the present disclosure relate, in general, to the field of text editing in electronic devices with touchscreens.

In this application the term electronic device is generally used. An electronic device referred to in this application could be any device where it is possible to use touch input on a touchscreen. Examples of such devices are of course mobile phones, Smartphones, tablets, laptops and computers etc. However, one must appreciate that capability to input information via a touchscreen could be built in almost any device e.g. a car, a lamp post, a scale and so on.

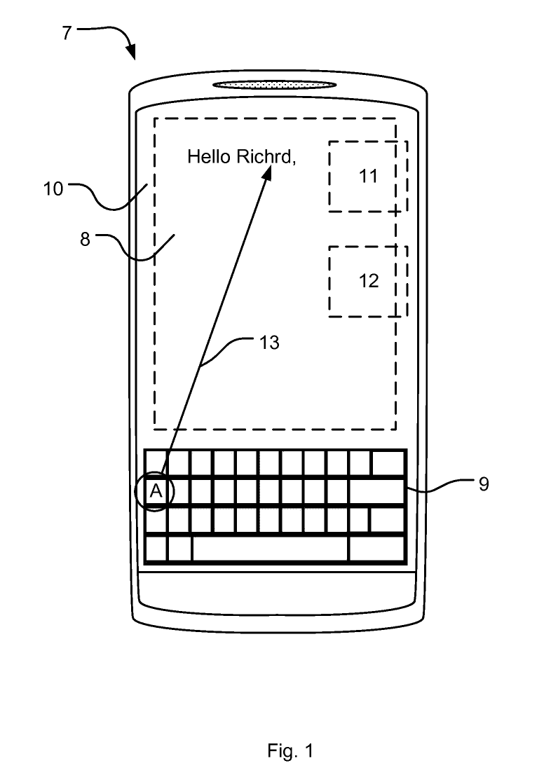

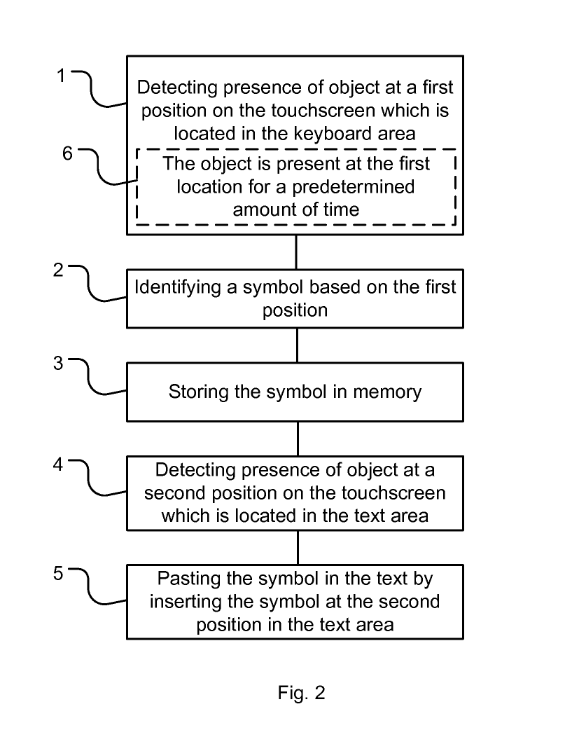

FIG. 1 illustrates an electronic device 7 where the method of editing text is executed. The electronic device comprises a touchscreen 10, configured to display a text area 8 comprising text to be edited and a keyboard area 9 comprising a number of symbols, a memory 11 and a processing unit 12. According to one aspect of the disclosure, the electronic device is a Smartphone, as shown in the figure, but it may be any kind of electronic device with a touchscreen as discussed above. In the electronic device 7, a user has inserted a text string “Hello Richrd”. Hence, the letter ‘a’ is missing. This error may easily be corrected using the proposed method, which will now be described referring to FIG. 2.

FIG. 2 illustrates a flow chart of the method performed in the electronic device 7 for editing a text. The electronic device comprises a memory 11 and a touchscreen 10 configured to display a text area 8 comprising the text to be edited and a keyboard area 9 comprising a number of symbols. The text area is an area on the touchscreen where the text appears when a user writes something on the keyboard of the electronic device or if the user of the device loads a text from the memory of the device which he/she wants to edit. The keyboard area is an area on the touchscreen where a keyboard is displayed where a user can chose which symbols to write.

The user typically initiates the text editing by pressing the missing symbol on the keyboard area. The first step of the method is to detect 1 the presence of an object at a first position on the touchscreen 10, wherein the first position is located in the keyboard area 9. The electronic device 7, then detects the object on the touchscreen in different ways depending on what kind of touchscreen it is. The way that an electronic device detects the position of an object on a touchscreen is known to the person skilled in the art and will not be explained further.

The second step of the method is to identify 2 one of the symbols based on the first position. By knowing where the different symbols of a keyboard are displayed, the electronic device 7 can determine what symbol the object has indicated by comparing the keyboard location with the detected first position.

The third step of the method is to store 3 the symbol in the memory. Hence, the symbol is temporarily stored in a memory 11, until a place where it shall be inserted is indicated.

The user then indicates the position in the text where the symbol is to be inserted by pressing the touchscreen 10 at a second position. This is e.g. done by dragging the object along the screen from the first position to the second position as will be further described below. The electronic device 7 then detects 4 the presence of an object at a second position on the touchscreen, wherein the second position is located in the text area 8. Detecting the presence of the object at a second position is done the same way as detecting the object at a first position as described above. The detection may be triggered by detection of a further action, which will be described further below.

The fifth step of the method is to paste 5 the symbol in the text by inserting the symbol at the second position in the text area 8. Since the symbol was previously stored in the memory 11, the symbol is accessed by copying it from the memory and inserting it at the second position in the text area. The text area is typically defined by a memory area, where the text being edited is stored. Hence, this step implies that the memory area is updated to comprise the symbol.

In other words, first the electronic device 7 identifies the presence of the object at a first position in the keyboard area 9 and the memory 11 stores the symbol which the object has indicated. The symbol is then pasted directly in the text area 8 at a position which is indicated by the object so that a simple way of correcting errors in a text or editing a text is provided. Furthermore, by using the method, there is no need to move the marker which indicates where in the text the user is currently writing. Such a marker is often used when editing text. In other words, the user may directly correct an error by inserting a symbol in the text without moving the marker.

The electronic device 7 will now be described in further detail.

The touchscreen 10 is an electronic visual display that the user can control through simple or multi-touch gestures by touching the screen with one or more objects. The touchscreen is for example a resistive, a capacitive or surface acoustic wave touchscreen.

The memory 11 can be any combination of a Read And write Memory, RAM, and a Read Only Memory, ROM. The memory 11 may also comprise persistent storage, which, for example, can be any single one or combination of magnetic memory, optical memory, or solid state memory or even remotely mounted memory.

The processing unit 12 may be constituted by any suitable Central Processing Unit, CPU, microcontroller, Digital Signal Processor, DSP, etc. According to one aspect of the disclosure, the processing unit is capable of executing computer program code for causing the electronic device 7 to execute specific actions. The steps, functions, procedures and/or blocks described above and below may, as an alternative, be implemented completely or partly in hardware using any conventional technology, such as discrete circuit or integrated circuit technology, including both general-purpose electronic circuitry and application-specific circuitry. The memory and the processor are then replaced by corresponding hardware blocks.

The processing unit 12 is arranged to detect the presence of an object at a first position on the touchscreen 10, wherein the first position is located in the keyboard area 9. The processing unit is further arranged to identify one of the symbols based on the first position, store the symbol in the memory 11, detect the presence of an object at a second position on the touchscreen, wherein the second position is located in the text area 8 and paste the symbol in the text by inserting the symbol at the second position in the text area. These steps have been described above when discussing the method and FIG. 2. By providing the touchscreen, the memory and the processing unit which performs the steps, the steps stated above are implemented in the electronic device and a way to simplify editing of a text in the electronic device is provided.

By providing the above method and electronic device 7, it is made possible for a user of the electronic device to edit text in a simple way. The user indicates on the touchscreen 10 which symbol he/she wants to use and then indicates in the text where he/she wishes the symbol to be inserted. This is useful when writing texts with word prediction or auto correction since such systems are sometimes wrong and misspells words. It is also useful when the user writes the text without such a system because it is easy to misspell words by forgetting a symbol.

From the user's point of view, the user of the electronic device edits text by:
Pressing a symbol on the keyboard with an object. The symbol is copied to the memory.
Pressing the object on a location in the text area where he/she wants to insert the symbol.
The user removes the object where he/she wants to paste the letter. The symbol is copied from the memory and pasted in the word/text.

According to one aspect of the disclosure, the symbol is displayed within a predetermined distance of the position where the presence of the object is detected. In other words, the symbol is displayed in close vicinity to the object when the presence of an object has been detected. By displaying the symbol in the vicinity of the position where the object is detected, the user receives visual confirmation of which symbol he/she has chosen. The predetermined distance is the determined such that the symbol is displayed so that it is visible for a user. The symbol may be displayed at a predetermined distance from the object on any side of the object. The side is determined such that the symbol is as visible as possible to the user. The predetermined distance and which side to display the symbol on are determined while keeping the maximum visibility of the symbol for the user in mind. If the object is for example a stylus, the predetermined distance may be shorter than if the object is a finger, which has a wider touch area. According to one aspect of the invention the predetermined distance is any distance between 0 and 10 mm. According to one aspect of the invention the predetermined distance is 2, 3, 4 or 5 mm.

According to one aspect of the present disclosure the presence of the object is constantly detected at the touchscreen 10 when the object is moved between the first and the second position. In other words, the object is dragged 13 over the surface of the touchscreen between the first and the second position by a user. In other words, the user may be seen as choosing a symbol on the keyboard, dragging it to the desired position in the text, and dropping it there. This feature makes the usage of the present disclosure intuitive for a user; if the user wants a symbol at a certain position in the text, he/she drags it there from the keyboard. If a symbol is missing somewhere in a text which the user is editing the user indicates which symbol to be inserted at a certain place in the text by dragging an object from the location of the chosen symbol in the keyboard area to the place in the text area where the user want the symbol pasted.

According to one aspect of the present disclosure the detection of the presence of the object at the second position involves detection of a further action. This is used so that the electronic device 7 will know where to paste the symbol in the text area 8 and not do so as soon as the object enters the text area, because the object may move over the text area until the correct position is detected. The further action is for example that the object is held still at the desired second position for a predetermined amount of time or that the object is lifted from the touchscreen at the desired position. The predetermined amount of time may be any time between 0.1 and 1 second. The further action may be any action that indicates to the electronic device that the object has moved to the desired position to place the symbol.

Then, the user of the electronic device edits text by:
Pressing a symbol on the keyboard with an object. The symbol is copied to the memory.
Holding and dragging the symbol to the text area.
Removing the finger where he/she wants to paste the letter. The symbol is copied from the memory and pasted in the word/text.

In other words, when the user presses the symbol, it should be copied to the memory 11. Then the user drags the symbol to the text area, and when he/she places his/her finger/the object on the intended location on the text area where the symbol should be placed, the symbol should be pasted in there from the memory.

Another useful implementation of the present disclosure is in electronic devices that children use to learn how to write. A child can then try to text words by using the above method and when the child realizes that some symbols are missing it is easy to insert them afterwards.

According to one aspect of the disclosure, the symbol is constantly displayed within a predetermined distance of the position where the presence of the object is detected when the object is moved between the first and the second position. The determination of the predetermined distance is discussed above. By displaying the symbol in the vicinity of the position where the object is detected while moving the object between the first and the second position, the user receives visual confirmation of which symbol he/she has chosen as well as a visual indication of where the symbol is being dragged.

According to one aspect of the invention the symbol is pre-displayed in the text when the presence of the object is detected at the second position on the touchscreen. In other words, the symbol is displayed in the text such as it would be placed if the letter was copied there. If the user is content with the result, he/she then removes the object from the touchscreen and the symbol is pasted at the position. Hence, in this case the detection of the presence of an object at a second position is triggered when the release of the object is detected.

The feature of displaying the symbol in the vicinity of the object is useful when the method and the electronic device are used by children who are learning how to write. When the child can see the symbol next to the object he/she uses to drag the symbol with, all the way from the first position on the keyboard 9 to the second position in the text area 8, the child can try to drag the symbol to different places in the text and let go where he/she thinks that it is suitable. When the feature of pre-displaying the symbol in the text is added, it is even more intuitive for the child and the child can try different places for the symbol before pasting it.

According to one aspect of the present disclosure the step of detecting the presence of an object at a first position on the touchscreen further comprises that the object is present at the first position for at least a predetermined amount of time. By waiting a predetermined amount of time before detecting the presence of an object the method is clearly distinguished from other methods of typing and/or inserting text. Hence, the user triggers the proposed method by placing his/her finger or another object at the symbol he/she wants to insert for a predetermined time.

This feature is useful when the present disclosure is used in an electronic device which also uses another text input method, such as Swype. To clearly distinguish the present disclosure from for example Swype, so that the electronic device may determine which method the user is intending to use, the electronic device can be set to recognize the use of the present disclosure when the object is present at the first position for a predetermined amount of time. The predetermined amount of time is for example one second. The predetermined amount of time is for example one and a half second. The predetermined amount of time may be any amount of time over half a second. In other words, if a user uses the method of the present disclosure together with Swype when editing a text, it is possible for the electronic device to distinguish the use of the different methods. In other words, if the present disclosure and Swype are used in the same electronic device, the device is able to distinguish between the two by determining how long the object is present at the first position. When using Swype, the user will start at a symbol but right away swipe the object on to another symbol. According to one aspect of the present disclosure the electronic device knows that the method according to the present disclosure should be implemented if the object is present at the first position for a predetermined amount of time.

According to one aspect of the invention, the user will know when the object has been present long enough and the symbol has been stored in the memory by seeing the symbol displayed within a predetermined distance of the position where the presence of the object is detected. In other words, the symbol is displayed within a predetermined distance of the position where the presence of the object is detected when the presence has been detected for at least a predetermined amount of time.

According to one aspect of the present disclosure the electronic device can distinguish the method according to the present disclosure from other text editing methods in that the user touches the first position in the keyboard first and then directly after touches the second position in the text area. The electronic device then knows that if single symbol was indicated on the keyboard, that symbol is to be inserted at the second position.

The different embodiments of the present disclosure are thus chosen depending on the presence of other text editing methods in the electronic device.

According to one aspect of the present disclosure the object is a stylus or a finger. Using a stylus or a finger for indicating the first and the second position is practical for the user. Depending on the type of touchscreen, other objects may be possible to use. For example a glove with specific touchscreen fingertips may be used.

According to one aspect of the disclosure the symbol is any of: a letter, a number, space, a character and/or punctuation. Any such symbol is used when editing text.

A character is for example ‘@’, ‘£’, ‘$’, ‘%’, ‘&’, ‘[’ and ‘}’. A character may also be a character in for example Chinese, Korean and/or Japanese or any language which uses characters in writing.

A punctuation is a symbol that indicates the structure and organization of written language, as well as intonation and pauses to be observed when reading aloud. A punctuation is for example: ‘.’, ‘;’, ‘,’, ‘:’, ‘-’, ‘(‘and’)’.

The symbol may be any kind of symbol that is displayed in the keyboard in the keyboard area. The symbol is for example a smiley.

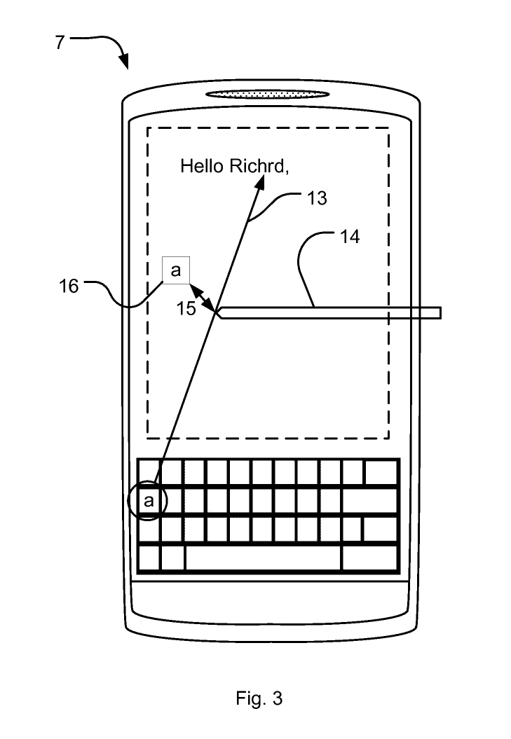

FIG. 3 illustrates an example of the present disclosure where an object 14 is dragging 13 a symbol from the keyboard to the desired position in the text on an electronic device 7. The symbol is displayed 16 at a predetermined distance 15 from the position of the object as discussed above. In the illustrated example, the missing symbol in the text is an ‘a’ and the object is a stylus.

According to one aspect of the present disclosure, it provides for a computer program, comprising computer readable code which, when run on a processing unit in an electronic device, causes the processing unit to perform the method according to above.

The disclosure is not limited to the specific flowchart presented, but includes all variations within the scope of the present claims.

As will be realized, the disclosure is capable of modification in various obvious respects, all without departing from the scope of the appended claims. Accordingly, the drawings and the description thereto are to be regarded as illustrative in nature, and not restrictive.

1. A method for editing a text in an electronic device, the electronic device comprising a memory and a touchscreen configured to display a text area comprising the text to be edited and a keyboard area comprising a number of symbols, wherein the method comprises the steps of:
detecting a presence of an object at a first position on the touchscreen, wherein the first position is located in the keyboard area;
identifying one of the symbols based on the first position;
storing the symbol in the memory;
detecting the presence of an object at a second position on the touchscreen, wherein the second position is located in the text area; and
pasting the symbol in the text by inserting the symbol at the second position in the text area.

2. The method according to claim 1, wherein the symbol is displayed within a predetermined distance of a position where the presence of the object is detected.

3. The method according to claim 1, wherein a presence of the object is constantly detected at the touchscreen when the object is moved between the first and the second position and wherein the detection of the presence of the object at the second position involves detection of a further movement.

4. The method according to claim 3, wherein the symbol is constantly displayed within a predetermined distance of a position where the presence of the object is detected when the object is being moved between the first and the second position.

5. The method according to claim 1, wherein the step of detecting the presence of the object at the first position on the touchscreen further comprises determining that the object is present at the first position for at least a predetermined amount of time.

6. The method according to claim 1, wherein the object is a stylus or a finger.

7. The method according to claim 1, wherein the symbol is any of: a letter, a number, space, a character or a punctuation.

8. An electronic device comprising:
a touchscreen configured to display a text area comprising text to be edited and a keyboard area comprising a number of symbols;
a memory;
a processing unit arranged to:
detect a presence of an object at a first position on the touchscreen, wherein the first position is located in the keyboard area;
identify one of the symbols based on the first position;
store the symbol in the memory;
detect the presence of an object at a second position on the touchscreen, wherein the second position is located in the text area; and
paste the symbol in the text by inserting the symbol at the second position in the text area.

9. The electronic device according to claim 8, wherein the symbol is displayed within a predetermined distance of a position where the presence of the object is detected.

10. The electronic device according to claim 8, wherein a presence of the object is constantly detected at the touchscreen when the object is being moved between the first and the second position and wherein the detection of the presence of the object at the second position involves detection of a further movement.

11. The electronic device according to claim 10, wherein the symbol is constantly displayed within a predetermined distance of a position where the presence of the object is detected when the object is being moved between the first and the second position.

12. The electronic device according to claim 8, wherein the processing unit is further arranged to detect the object at the first position when the object is present at the first position for at least a predetermined amount of time.

13. The electronic device according to claim 8, wherein the object is a stylus or a finger.

14. The electronic device according to claim 8, wherein the symbol is any of: a letter, a number, space, a character or a punctuation.

15. A computer program, comprising computer readable code which, when run on a processing unit in an electronic device, causes the processing unit to perform the method as claimed in claim 1.
